(19) United States
(12) Patent Application Publication
(10) Pub. No.: US 2026/0120447 A1
(43) Pub. Date: Apr. 30, 2026

(54) AI VIDEO SENSOR FOR REAL TIME ENVIRONMENT DIGITAL TWIN

(71) Applicant: Aliensense Limited, Abu Dhabi (AE)

(72) Inventors: Andrei Rychazhnikov, Abu Dhabi (AE); Alex Lapir, Dubai (AE)

(21) Appl. No.: 18/930,134

(22) Filed: Oct. 29, 2024

(51) Int. Cl. G06V 10/82; G06T 7/292; G06T 7/55; G06V 10/764; G06V 10/98; G06V 20/20; G06V 20/40; H04N 7/18

(52) U.S. Cl. CPC G06V 10/82; G06T 7/292; G06T 7/55; G06V 10/764; G06V 10/993; G06V 20/20; G06V 20/41; H04N 7/183; G06T 2207/20081; G06T 2207/20084; G06T 2207/30181; G06T 2207/30241

(57) ABSTRACT

Systems and methods for creating a digital twin of a physical environment. Object recognition and processing are executed at an edge device such as an AI video sensor, significantly reducing the need for backend computation using synchronized object libraries stored on both the edge devices and the backend system.

### TECHNICAL FIELD

Embodiments relate generally to digital twinning and environment monitoring. More particularly, embodiments relate to synchronizing digital twin object libraries.

### BACKGROUND

Traditional digital twin and monitoring systems rely on transmitting large amounts of video data from sensors to backend systems for backend processing and analysis. This approach leads to high bandwidth usage, increased latency, and potential data loss, especially in environments with limited network resources. Such systems are inefficient, as backend systems bear the brunt of data processing, requiring substantial computational resources and resulting in delayed or inaccurate updates.

Additionally, traditional systems typically use static object recognition models that may not adapt well to changing environments or diverse object types. These limitations result in inefficient real-time monitoring, reduced accuracy in object detection and classification, and challenges in creating and updating digital twins of physical spaces in a timely and resource-efficient manner. Furthermore, there is typically no direct synchronization between object recognition models at the edge and the backend visualization systems, leading to inconsistencies in data interpretation and digital representation.

Therefore, there is a need for systems and methods that provide synchronized object libraries by efficient data transmission, enabling the creation of detailed digital twins using minimal data transfer and enhancing real-time monitoring capabilities across various applications.

### SUMMARY

Embodiments described or otherwise contemplated herein substantially meet the aforementioned needs of the industry. In an embodiment, systems and methods for digital twin synchronization and real-time environment monitoring provide synchronized object libraries and efficient data transmission methods applied by edge devices and backend systems for creating and updating digital representations of physical spaces. In one aspect, object recognition and processing are executed at the edge device (e.g. AI video sensor), significantly reducing the need for backend computation. Embodiments utilize synchronized object libraries stored on both the edge devices and the backend system. This synchronization guarantees that objects detected by the sensors are represented consistently across the entire system.

Embodiments utilize minimal data transfer through object recognition and parameterization techniques for the creation and updating of digital twins, thereby improving situational awareness and monitoring capabilities in various applications such as surveillance, autonomous navigation, and industrial Internet of Things (IoT) deployments, monitoring and control systems, process control, public safety, battlefield systems control, advertising and marketing monitoring systems, traffic control systems, among other applications.

In a feature and advantage of embodiments, an edge device (e.g. AI video sensor) processes image data locally, using pre-trained convolutional neural network (CNN) models to identify objects.

In another feature and advantage of embodiments, minimal data is transferred (e.g. from an AI sensor to a backend monitoring system twin). As highlighted in the foregoing example, only object parameters as classified by a CNN rather than heavy image data is transferred, which leads to faster and more reliable communication. In one aspect, the edge device sends only essential object parameters—such as direction, distance, and size-rather than full image frames. The backend system (or even several systems) then receives this information and focuses solely on dynamically reconstructing and visualizing the digital twin based on the compact data received.

In another feature and advantage of embodiments, synchronization of libraries between edge devices and backend systems improves the capability of systems and methods to reflect real-time changes in the environment. For example, because minimal data transfer is utilized, object libraries can be more frequently updated compared to traditional systems.

In another feature and advantage of embodiments, the bandwidth requirements on the communication channel are reduced, thereby increasing stability, reliability, noise immunity, secrecy, and protection from unauthorized access. Relatedly, a significant reduction in the load on the central computing system is achieved, which can be advantageous in conditions where image transmission is difficult.

In another feature and advantage of embodiments, system architecture allows for scalable and efficient monitoring without the need for centralized data processing. Various deployment configurations, such as single or multiple synchronized video sensors, are provided, thereby allowing flexibility for different monitoring scenarios.

In an embodiment, a method of creating a digital twin of a physical environment comprises acquiring a real-time image frame (IF) by at least one AI video sensor positioned in the physical environment; processing, by the at least one AI video sensor, the IF using a convolutional neural network (CNN), for an object in the IF using an object library on the AI video sensor: identify an object class, determine a probability of recognition of the object, perform pose estimation for the object, and determine coordinates of the object within the IF; determining, by the AI video sensor, a distance to the object by at least one of using an external sensor or triangulating with at least two video sensors having known fields of view and distances between sensors; calculating, by the AI video sensor, coordinates of the object within the physical space; repeating the acquiring, processing, determining, and calculating for a next image frame (IF+1); performing, by the AI video sensor, prefiltering to exclude false positives of the object or the coordinates of the object using IF and IF+1 as prefiltered object information; transmitting, by the AI video sensor, the prefiltered object information as a compact data message to a remote backend for dynamically reconstructing the digital twin, the compact message including: the object class, an object direction, the pose estimation, a timestamp, an AI video sensor ID, and the coordinates of the object.

In an embodiment, an edge device comprises at least one image sensor positioned in a physical space; an object library; at least one processor and a memory operably coupled to the at least one processor; instructions that, when executed by the at least one processor, cause the edge device to implement: triggering the at least one image sensor to capture a real-time image frame (IF), a convolutional neural network (CNN) trained based on the object library configured to process the IF for the object library, and configured to, for an object in the IF using the object library, identify an object class, determine a probability of recognition of the object, perform pose estimation for the object, and determine coordinates of the object within the IF, an object coordination engine configured to: determine a distance to the object by at least one of using an external sensor or triangulating with at least two video sensors having known fields of view and distances between sensors, calculate coordinates of the object within the physical space, and repeating the acquiring, processing, determining, and calculating for a next image frame (IF+1); wherein the object coordination engine is further configured to prefilter to exclude false positives of the object or the coordinates of the object using IF and IF+1 as prefiltered object information; the instructions further comprising an edge communication engine configured to transmit the prefiltered object information as a compact data message to a remote backend for dynamically reconstructing the digital twin, the compact message including: the object class, an object direction, the pose estimation, a timestamp, an AI video sensor ID, and the coordinates of the object.

In an embodiment, a system comprises a first image sensor positioned in a physical space; a first positioning subsystem configured to determine first positional data for an object in a first image frame (IF) captured by the first image sensor; a first camera configured with a convolutional neural network (CNN) trained based on an object library configured to process the first IF for an object library associated with a digital twin, and configured to, for an object in the first IF using the object library and the first positional data, determine object information in the first IF including an object class, an object direction, a pose estimation, and object coordinates; a second image sensor positioned in the physical space; a second positioning system configured to determine second positional data for an object in a second image frame (IF) captured by the second image sensor; a second camera configured with a convolutional neural network (CNN) trained based on an object library configured to process the second IF for the object library, and configured to, for an object in the second IF using the object library and the second positional data, determine object information in the second IF including an object class, an object direction, a pose estimation, and object coordinates; a global server configured to: receive, over a high bandwidth interface, the object information of the first camera and the second camera, aggregate the object information of the first camera and the second camera as aggregated object information, synchronize the aggregated object information as synchronize aggregated object information, and transmit the synchronized aggregated object information to the digital twin.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system for digital twin synchronization and real-time environment monitoring, according to an embodiment.

FIG. 2 is an operational block diagram of an edge device as an AI-enabled camera, according to an embodiment.

FIG. 3 is a block diagram of a system for digital twin synchronization and real-time environment monitoring, according to an embodiment.

FIG. 4 is a block diagram of a system for digital twin synchronization and real-time environment monitoring, according to an embodiment.

FIG. 5 is a block diagram of a system for digital twin synchronization and real-time environment monitoring, according to an embodiment.

FIG. 6 is a block diagram of a system for digital twin synchronization and real-time environment monitoring, according to an embodiment.

FIG. 7 is a block diagram of a system for digital twin synchronization and real-time environment monitoring, according to an embodiment.

FIG. 8 is a block diagram of a system for digital twin synchronization and real-time environment monitoring, according to an embodiment.

FIG. 9 is an illustration of calculations for an unsynchronized camera setup for digital twin synchronization and real-time environment monitoring, according to an embodiment.

FIG. 10 is an illustration of calculations for a synchronized camera setup based on timestamp for digital twin synchronization and real-time environment monitoring, according to an embodiment.

FIG. 11 is an illustration of calculations for a camera setup based on vertical and horizontal angles of objects for digital twin synchronization and real-time environment monitoring, according to an embodiment.

FIG. 12 is an illustration of calculations for a camera setup based on camera positioning characteristics for digital twin synchronization and real-time environment monitoring, according to an embodiment.

FIG. 13 is a method of digital twin synchronization and real-time environment monitoring, according to an embodiment.

The embodiments described are exemplary ways to use the invention to solve technical problems in the field of the invention. The solutions and techniques disclosed may also be used to solve other problems in the field or to solve similar problems in other fields. Substitutions, modifications, and equivalents known to those of skill in the art may be used to implement these solutions and techniques, consistent with scope of the invention described in the claims.

### DETAILED DESCRIPTION

Embodiments described herein include systems and methods for the generation of a synchronized object library between a sensor and a backend monitoring system. For example, an imaging sensor can include a camera that forms a raster image from a real-word environment.

In one aspect, a raster image can be generated by a matrix sensor or scanning linear, including for example, a charge-coupled device (CCD), Complementary Metal-Oxide-Semiconductor (CMOS), Electro-Optical (EO), Infra-Red (IR), Short-wave infrared (SWIR), or Long-wave infrared (LWIR) image capture device.

Embodiments analyze the image(s) and build a digital twin of the environment dynamically. In one aspect, a CNN such as YOLO8 is utilized to analyze the image for classification, detection, segmentation, pose estimation. In one aspect, an object within the image can be determined by, for example, ResidualNet for classification and/or verification. In one aspect, the distance to the object from the sensor can be determined.

In one aspect, determining the distance to an object comprises using an external sensor, such as radar, lidar, echo sounder (for underwater viewing), laser rangefinder, ultrasonic distance sensor, etc. In one aspect, determining the distance to an object comprises optical methods, such as triangulation (e.g. using two or more cameras with a spaced base and overlapping observation zones). In another optical method, known lens characteristics are used to perform geometric measurements based on the image of one camera, angle of view, focus, zoom, distortion, using the laws of optical perspective orientation to the position of previously known objects or points on the ground in the frame.

Embodiments can accordingly generate or otherwise recreate a digital twin based on the sensor's observations. In one aspect, embodiments can transmit minimal data from the sensor to the monitoring center, allowing for efficient and detailed digital twin creation. Embodiments utilize a library of objects where each object is identified by a unique ID and characterized by specific parameters, such as:
ID: Unique identifier for the object (e.g., “000x8F” for a male figure).
Direction (a): The angle relative to the sensor (0-360 degrees).
Distance (d): The distance from the sensor (0 to infinity in cm).
Size(s): The linear height (e.g. estimated) of the object (0 to infinity in cm).

When the sensor recognizes an object, the sensor sends a compact command to the monitoring center, such as CREATE_OBJECT (000x8F, a, d, s), which allows the backend to recreate the object in a digital twin of the environment observed by the sensor with the transmitted parameters.

In one aspect, both the edge device (sensor) and the backend system share a synchronized library of objects, providing consistency in object recognition and representation. In particular, in one aspect, the CNN implemented in the edge device has been trained or pretrained to recognize the same types of objects which have appropriate avatars in the digital twin's library. A primary aspect of synchronization is to transmit the appropriate identifiers of the object known to the digital twin library so the digital twin subsystem can image the object properly. For example, all of the objects identified by the edge device are recognizable in the digital twin's library. In another example, all significant objects (but not all objects) identified by the edge device are recognizable in the digital twin's library. In one aspect, to recognize and draw a new type of object, the new object avatar is added to the twin system and the CNN is trained to recognize the new object.

In one aspect, efficient data transmission is achieved by transmitting only the parameters of recognized objects instead of transmitting heavy image data for processing. This approach reduces bandwidth usage and improves the speed and reliability of data transmission. System rules can require transmitting certain “default object” data in case the CNN does not recognize a given object with a predetermined threshold of certain probability but does recognize it with a predetermined threshold of uncertain probability. In one aspect, embodiments include an additional analyzer capabilities on board the edge device, such as for moving object detection. In this case, embodiments can transmit a message about a default or uncertain object according to predetermined rules, such as ignore, transmit every frame, or transmit at a reduced frequency. In certain aspects, if the edge device has only CNN onboard then an unrecognized object just will not be recognized or “seen” by the backend twin.

In one aspect, real-time digital twin creation is provided by continuously updating the digital twin based on the edge device observations. Accordingly, embodiments can provide a dynamic representation of the environment, which is important for applications like monitoring and surveillance. In one aspect, a minimum update criteria is a single image frame. For example, new image data is updated according to a trigger of the image sensor creating a new frame. In one aspect, a maximum time period is not limited and is practically only limited by the image sensor continuing to function properly.

In one aspect, sequential detection and immediate twinning includes detecting objects at the edge device and immediately (e.g. per frame) reflects those detections in the digital twin, which can be beneficial for real-time decision-making.

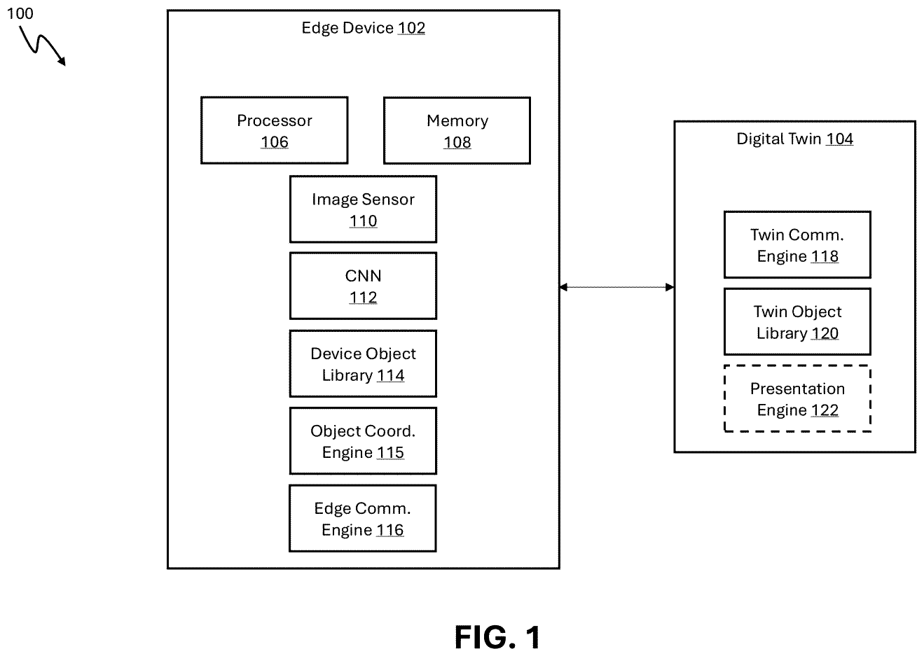

Referring to FIG. 1, a block diagram of a system 100 for digital twin synchronization and real-time environment monitoring is depicted, according to an embodiment. System 100 generally comprises edge device 102 and digital twin 104.

Embodiments described herein include various engines, each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC), graphic processing unit (GPU) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Edge device 102 comprises a computing device that acts as an interface between the real world and a backend (e.g. data center, digital twin, etc.). In an embodiment, edge device 102 can be positioned to be on a boundary between digital processes and the physical environment. Edge device 102 comprises a processor 106, a memory 108, an image sensor 110, a CNN 112, a device object library 114, an object coordination engine 115, and an edge communication engine 116.

Processor 106 is a programmable device that accepts digital data as input, is configured to process the input according to instructions or algorithms, and provides results as outputs. In an embodiment, processor 108 can be a central processing unit (CPU) configured to carry out the instructions of a computer program. Processor 106 is therefore configured to perform at least basic arithmetical, logical, and input/output operations.

Memory 108 is operably coupled to processor 106 and can comprise volatile or non-volatile memory as required by processor 108 to not only provide space to execute the instructions or algorithms, but to provide the space to store the instructions themselves. In embodiments, volatile memory can include random access memory (RAM), dynamic random access memory (DRAM), or static random access memory (SRAM), for example.

Image sensor 110 comprises an imager that detects and conveys information used to form an image. For example, image sensor 110 can be a charge-coupled device (CCD) or active-pixel sensor (CMOS sensor). In an embodiment, image sensor 110 can comprise a camera.

CNN 112 comprises a feed-forward neural network, and can include an input layer, hidden layers and an output layer. In one aspect, CNN 112 is configured to identify and classify objects in image data.

Device object library 114 comprises a database of objects of which CNN 112 is configured to identify. Device object library 114 can be preconfigured with a set of objects identifiable by CNN 112 and added-to as CNN 112 learns additional objects. In any case, device object library 114 is associated with the object identification ability of CNN 112.

Object coordination engine 115 is configured to determine the position of the object relative to the image or other captured or static images. For example, object coordination engine 115 is configured to analyze image data and/or metadata (e.g. object class, probability of its belonging to this class, coordinates inside the frame, estimation of the object's pose, camera coordinates in space, lens orientation in space, data from an external sensor, frame timestamp) and determine object position or movement.

In an embodiment, object coordination engine 115 can further conduct prefiltering of the determined object information to exclude any false positive determinations from CNN 112. For example, in a set of image frames, an object identified in one or more initial frames can be predicted for location in subsequent frames by using Kalman filter, for instance. If the object location determined in the subsequent frames does not match the predicted location (or a new unexpected object is determined), the object or object position can be determined to be false positives and excluded from transmission to digital twin 104.

Prefiltering within can include a series of checks and balances where the engine assesses the continuity and validity of object tracking across a few frames. When an object is identified by the CNN in an initial set of frames, the engine utilizes predictive modeling to forecast its trajectory and expected location in subsequent frames. This forecasting is based on an accumulation of object movement data and contextual interactions, adjusted for any external influences that might affect trajectory, such as physical obstructions or sudden changes in the object's velocity.

The use of the Kalman filter, in this context, allows for a refined approach where the expected state of an object is calculated considering the dynamic changes and the inherent uncertainties in environmental perception. This predictive mechanism helps in determining if an object's subsequent location aligns with its forecasted trajectory. If the actual position substantially deviates from the predicted path, or if a new object appears without prior indication, embodiments identify these discrepancies as potential false positives, or are otherwise excluded.

Furthermore, embodiments are configured to dynamically adapt its object detection and tracking algorithms based on environmental inputs. For example, changes in lighting, weather conditions, or the introduction of new obstacles can trigger adjustments in the object recognition parameters to maintain high accuracy in real-time monitoring.

Edge communication engine 116 is configured to format and communicate data from edge device 102 to digital twin 104 for the purposes of digital twin creation (e.g. synchronization). In one aspect, edge communication engine 116 is configured to transmit a compact or minimal data packet. In one aspect, edge communication engine 116 is configured to selectively transmit information about certain object types. For example, recognized objects can be transmitted to the remote backend monitoring system (e.g. digital twin), while information about other object types (non-recognized) are ignored or transmitted at a reduced frequency than recognized objects.

Selective transmission can be based on a predefined criteria. In one aspect, predefined criteria can include object importance determined by operator settings or system requirements. For example, an operator can set the rules as to what types of objects to recognize and update the digital twin and what types of objects should be ignored. For instance, in certain situations it is desirable to understand whether humans and cars in a given area, and to ignore animals such as dogs. Accordingly, rules are defined as to how often to get the information of different types of objects (e.g. humans every frame, buses-one time in 10 frames and dogs one time in 100 frames, ignore all birds in any frame). Embodiments can also categorize objects based on an object velocity or the context of an object's appearance. For instance, objects moving at a speed above a certain threshold could be transmitted more frequently to capture dynamic events, such as high-speed vehicles in traffic management scenarios. Conversely, static objects like street furniture may be transmitted infrequently unless they change position or are involved in an incident. Additionally, the criteria can adjust based on environmental conditions-during a weather event, for example, the transmission frequency for outdoor surveillance cameras can increase to monitor flooding or debris. Such adaptive criteria provide the digital twin with data which is both relevant and efficiently utilized, minimizing unnecessary data transmission and focusing on situational priorities.

In another aspect, edge communication engine 116 transmits object information when the object changes position, appears, or disappears in the frame, or changes pose so as to update the digital twin with relevant changes.

In another aspect, upon authorization by an authorized user, edge communication engine 116 can transmit encrypted image frames or sequences of image frames, in addition to the compact message. Accordingly, only an authorized operator can view the image frame content, allowing embodiments to perform security functions without violating privacy.

Digital twin 104 is a virtual model of a physical object (e.g. the environment captured by image sensor 110). Digital twin 104 uses real-time data sent from image sensor 110 to simulate the behavior and monitor operations. Digital twin 104 generally comprises twin communication engine 118, twin object library 120, and optionally, presentation engine 122. Though not depicted, digital twin 104 can comprise a processor and operably coupled memory for implementation of the components of digital twin 104.

Twin communication engine 118 is configured to receive and unpack data communicated from edge device 102. For example, twin communication engine 118 can receive the compact or minimal data packet transmitted by edge communication engine 116 and parse the message for object identifiers of objects in twin object library 120.

Twin object library 120 comprises a database of objects of which CNN 112 is configured to identify. Twin object library 120 can be preconfigured with a set of objects identifiable by CNN 112. In an embodiment, twin object library 120 is initially synchronized with device object library 114 such that the libraries contain the same object definitions, or at a minimum, that device object library 114 utilizes only objects in twin object library 120.

Optionally, presentation engine 122 comprises a user interface for presenting the objects (and relative movement within the environment) of twin object library 120 identified by edge device 102.

In operation, image sensor 110 captures one or more images of an environment. CNN 112 identifies one or more objects in the image(s) and utilizes device object library 114 to define the object. Edge communication engine 116 assembles a communication packet including the detected object and communicates the packet to digital twin 104. Twin communication engine 118 receives and unpacks the packet. Twin communication engine 118 can retrieve or look up in twin object library 120 an object specified in the packet. Optionally, presentation engine 122 can present the object as captured in the image (e.g. in coordination with previous image data).

Though system 100 is depicted as a single edge device 102 and single digital twin 104, embodiments can include multiple edge device and/or multiple interconnected digital twins.

In an embodiment, a single video camera with a connected synchronized sensor is implemented. In one aspect, the time of imaging can either be synchronized at each sensor or each frame from each camera at least can include a precise timestamp to have the ability to compare the images from different sources. Accordingly, it can be ensured that images of the same scene at the same time from different points of view are captured. In one aspect, the camera generates an image frame and its associated edge device components recognizes in the frame an object for which the neural network has been trained.

Synchronously with identifying the class of the object and determining its coordinates within the frame, as well as its pose, data is received from an external sensor that determines the distance to the observed scene. With reference to “synchronously,” the sensor's measurement can be made at the exact time as exposure of the image by the camera so both can be matched (e.g. the image and data from radar, lidar, and/or other sensors). Information from an external sensor corresponding to the recorded direction to the recognized object is recorded in the frame metadata. The received metadata (e.g. object class, probability of its belonging to this class, coordinates inside the frame, estimation of the object's pose, camera coordinates in space, lens orientation in space, data from an external sensor, frame timestamp) is utilized in coordinate calculation.

Coordinate calculation is therefore based on the received metadata and determines the estimated position of the object in space. If the settings of the algorithm for filtering errors in determining the coordinates of an object have accumulated enough information for correct operation, the estimated position of the object can be adjusted within the limits allowed by the algorithm. For example, the more statistical data allows for prediction of the expected place of an object in a new image more accurately. In one embodiment, a minimum period of the filter's accommodation is two previous frames. If the error filtering algorithm has not accumulated enough data, the estimated location is considered true, and it is stored in the algorithm's stack. The calculated/corrected position of the object is added to the metadata and sent to the digital twin.

In an embodiment, a single video camera without a connected synchronized sensor is implemented. In one aspect, the camera generates an image frame and its associated edge device components recognizes in the frame an object for which the neural network has been trained. In one embodiment, predetermined marks are recorded in the frame, characterizing the position of previously known objects in the frame and the distance to them. For example, the position of known objects within the frame can be marked during the camera installation (e.g. based on the Eiffel tower in the observing scene and the known camera position) and accordingly an estimate of the distance from the camera to the object between the camera and the Eiffel tower within the image can be determined.

Frame metadata records information about the position of the object inside the frame, the optical characteristics of the lens (e.g. angle of view, field distortion, lens zoom characteristics, autofocus on/off), and the position of the marks of previously known objects. The resulting metadata (e.g. object class, probability of its belonging to this class, coordinates inside the frame, estimation of the object's pose, camera coordinates in space, lens orientation in space, coordinates of previously known objects, frame timestamp) is utilized in coordinate calculation.

Coordinate calculation is therefore based on the received metadata and roughly calculates the estimated position of the object in space. If the settings of the algorithm for filtering errors in determining the coordinates of an object have accumulated enough information for correct operation, the estimated position of the object can be adjusted within the limits allowed by the algorithm. If the error filtering algorithm has not accumulated enough data, the estimated location is considered true, and it is stored in the algorithm's stack for further analysis of subsequent frames. The calculated/corrected position of the object is added to the metadata.

In an embodiment, two or more synchronized cameras (e.g. hardware or via NTP protocol) with known relative positions, distances, and overlapping angles of view are implemented.

Synchronized cameras in which the start time and duration of the frame exposure are precisely known, respectively generate image frames from different angles and recognize in their respective frames the object for which the neural network of each camera is trained. In one aspect, triangulation is utilized for at least two cameras with overlapped fields of view (e.g. cameras sense the same object at a given time and the distance between cameras is known). The object size within each image from both cameras can thus be detected. Moreover, given the known start time of exposure, duration, and estimation of object's speed and direction of movement (e.g. using a Kalman filter), the smear caused by the object's movement can be reduced and the object's center can be detected more precisely.

In an embodiment, the metadata (object class, probability of its belonging to this class, coordinates inside the frame, estimation of the object's pose, camera coordinates in space, lens orientation in space, frame timestamp) are sent to a central server or, in the case of a distributed network consisting of a large number cameras, local server, to calculate the coordinates of detected objects.

In an embodiment, a system comprises strategically positioned local and global servers that play key roles in managing data traffic. Local and global servers optimize system performance and provide operational integrity and scalability. For example, local servers are configured to handle initial data processing and aggregation from connected devices, effectively reducing the load on the network by filtering and compressing data before it is sent to the global server. This tiered processing allows for the handling of large volumes of data in real-time, improving the system's responsiveness and efficiency. A global server, on the other hand, is tasked with integrating data streams from multiple local servers, performing complex analyses, and updating the digital twin. It employs advanced algorithms to provide data coherence and accuracy across the system, dynamically adjusting its processing capabilities based on the volume and complexity of incoming data. This architecture not only improves the scalability of the system—allowing it to adapt to increasing data inputs without degradation in performance—but also guarantees that the digital representation of the physical environment remains accurate and timely, which is critical for decision-making processes in real-time monitoring applications. This setup exemplifies a robust approach to data management, covering expansive and varying demands of modern digital twin technologies.

In one aspect, the local server calculates the estimated position of the object in space based on the received metadata from different cameras. If the settings of the algorithm for filtering errors in determining the coordinates of an object have accumulated enough information for correct operation, the estimated position of the object can be adjusted within the limits allowed by the algorithm. If the error filtering algorithm has not accumulated enough data, the estimated location is considered true, and it is stored in the algorithm's stack for further analysis of subsequent frames. The calculated/corrected position of the object is added to the metadata.

As in the aforementioned examples, the location and orientation in space of the imaging system can be determined by, for example, a global positioning system sensor connected and synchronized with the imaging system, allowing for the determination of the position and orientation relative to the known position of one or more satellites at a strictly defined moment in time. In another example, an a priori determination of the location using topographic reference to the terrain (including by map, using a compass, chronometer, barometer, sextant, etc., using an external global positioning system sensor, analysis of the location of a priori known objects in the frame) or an operator command. In one aspect, a topographic reference process typically begins with identifying known landmarks visible within the camera's frame or within proximity to its installation point. For example, an operator can manually input these coordinates into the system, leveraging a detailed topographic map or direct measurements taken on-site. This setup provides precise alignment of the system based on stable, recognizable ground features, providing a dependable reference point that improves the overall accuracy of the spatial data captured by the system.

In another example, a vectorized mapping and navigation system can be used. In one aspect, a known vectorized map can be applied to the image frame. The position location utilizing vectorized mapping is accomplished by comparing generated vectored maps based on the image frame with stored reference vectored maps. Use of vector mapping can include capturing real-time raster images of the scene, which are then processed through an edge detection filter to define initial vector borders. These filtered images are processed by a convolutional neural network (CNN) to create a vectored map. This vectored map is then compared with a reference vectored map to accurately determine the current location.

In a further embodiment, alongside the vectorized mapping and navigation system, the system is additionally equipped to incorporate non-vectorized map recognition techniques to improve location determination capabilities. This approach utilizes direct landscape image recognition, where convolutional neural networks (CNNs) are employed to analyze and interpret raster images of the environment without prior vectorization. The CNN processes these images to identify distinctive landscape features and landmarks directly, correlating them with stored landscape data to determine the object's current location. By integrating both vectorized and non-vectorized recognition systems, the system improves its robustness and accuracy in geospatial positioning and navigation, providing comprehensive coverage and enhanced reliability in diverse operational environments.

In another example, an inertial measurement unit (IMU) can be used. In one aspect, an IMU can be utilized to apply IMU-calculated or determined position location to the image frame. IMU functions by using accelerometers, gyroscopes, and sometimes magnetometers to calculate the position and orientation of an object based on the measurement of physical forces acting upon it. In this embodiment, the IMU provides positional data by measuring acceleration and angular velocity, which, when integrated over time, yields the object's velocity and displacement. This data can be used to determine an object's current position relative to a known starting point. The IMU's calculated position is then used to annotate the image frame with precise location metadata, improving the accuracy of object tracking and environmental interaction within the digital twin system.

As also in the aforementioned examples, methods for synchronizing multiple cameras with each other and with external sensors for determining the distance to an object can be implemented, including by using a global positioning system sensor connected and synchronized with the imaging system, allowing the position and orientation to be determined relative to the known position of one or more satellites at a strictly defined point in time. In another example, hardware synchronization can be implemented, such as by supplying a common sync pulse via GPIO or sending a message via the cross-board interface, etc. The use of a common sync pulse via GPIO provides a technique for hardware synchronization among multiple cameras and sensors. This technique guarantees that all connected devices capture data at precisely the same time, which is important for accurate positioning and motion analysis. By sending a sync pulse, each camera and sensor receive a simultaneous trigger signal that aligns their operation to a common time frame. This synchronization supports the precise calculation of object positions by comparing the data captured at the exact same moment from different angles, thereby improving the accuracy of spatial and movement analyses in systems such as digital twins.

In another example, connecting to an Ethernet network using Network Time Protocol (NTP) protocol can be utilized. The utilization of the NTP over an Ethernet network enables precise synchronization across devices, required for accurate position localization in systems involving multiple sensors or cameras. By confirming that all devices in the network have their clocks aligned to the millisecond or microsecond (e.g. the basis of the NTP), NTP allows embodiments to determine the exact timing of events and measurements taken by different devices. This synchronization is important when combining data from various sources to accurately locate positions in a monitored environment. For example, if two cameras capture the same event, NTP allows the system to correlate these events in time, facilitating accurate reconstruction of the event's position based on timestamps that are precisely synchronized.

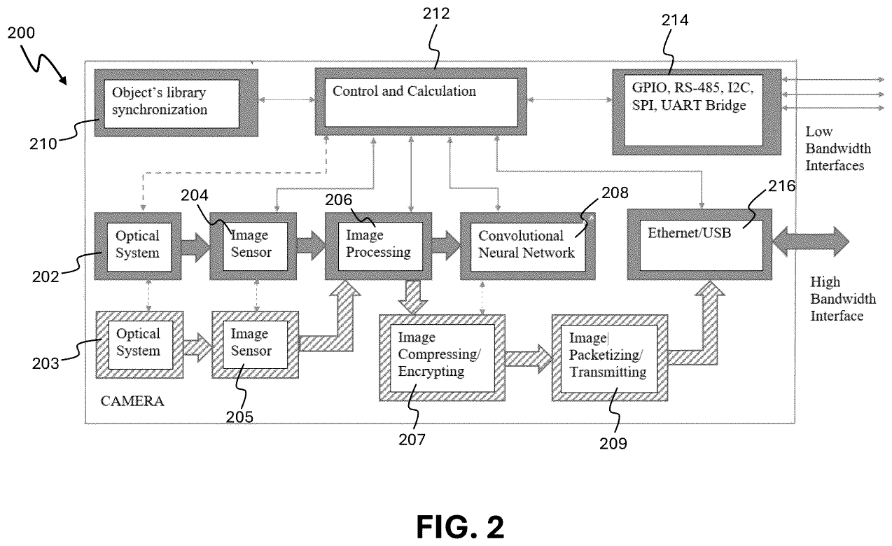

Referring to FIG. 2, an operational block diagram of an edge device 200 as an AI-enabled camera is depicted, according to an embodiment. In an embodiment, the components of the camera are illustrated, highlighting modules responsible for image capture, object recognition (via CNNs), and distance measurement (using onboard or external sensors). Data flow of data processing within the camera is also depicted, emphasizing edge-based processing.

In an embodiment, an optical system 202 (e.g. including a light source, lens(es), and mirror(s)) utilizes one or more image sensor(s) 204 for capturing an image. In general, camera 200 operation moves from optical system 202 to image sensor 204 to image processing engine 206 to convolutional neural network 208.

For example, control and calculation engine 212 adjusts the optical system 202 and triggers image sensor(s) 204 to capture an image. Image processing engine 206 is configured to process the image captured by image sensor 204, including by compression/encryption engine 207. The processed image can be applied to CNN 208 to determine a dataset of the image. An image dataset can include identification of an object class, determination of a probability of recognition of the object, performing pose estimation, or determination of coordinates of the object within the image frame. In an embodiment, a synchronization library 210 can be utilized by a control and calculation engine 212 to determine object characteristics in the image. In an embodiment, image packetizing/transmitting engine 209 can be utilized for data transfer.

In an embodiment, optical system 202 along with the image sensor 204 serve as the primary module for image capture within the camera unit. Alongside this, an optional optical system 203 and an additional image sensor 205 can be included to enable advanced functionality such as triangulation for precise depth and distance measurements. The camera utilizes this optional setup for dual imaging perspectives calculation within a single device to improve depth perception similar to binocular vision. Image sensor 204 captures the primary image data, which is then processed by image processing engine 206. If implemented, the optional image sensor 205 captures a secondary image from optical system 203. The dual images, when used, facilitate triangulation by comparing differences between the images captured at slightly different angles considering known distance between sensors, thereby providing accurate depth information about the observed objects. Processed images from both sensors by an algorithm of disparity detection followed by calculation of distance by a parallax (or triangulation) method (if the optional components are used) are then analyzed by convolutional neural network (CNN) 208. Furthermore, a control and calculation engine 212 utilizes a synchronization library 210 to effectively manage and synchronize data input from both the primary and optional secondary image sensors.

A low-speed interface configuration such as by low-speed input/output 214 (e.g. general-purpose input/output (GPIO), RS-485, I2C, SPI, UART bridge), illustrates a system setup where cameras communicate with each other using a low-speed interface. This configuration supports onboard object positioning analysis using multiple cameras, reducing the need for a central server. A ‘low-speed’ interface is an interface that does not support the transmission of live video streams, typically limited to data transmission rates insufficient for real-time video. These interfaces, including GPIO, RS-485, 12C, SPI, and UART, allow for transmission speeds that do not exceed a few megabits per second. In contrast, ‘high-speed’ interfaces, which support live video, generally operate at much higher data rates, sufficient to handle streaming of video data in real-time, typically ranging from hundreds of megabits to several gigabits per second.

A broadband interface configuration such as by high-speed input/output 216 (e.g. Ethernet/USB/MIPI CSI-2/FPD Link/GMSL/HDMI/DigitalPort) illustrates a system setup in which multiple cameras can be connected via a high-speed interface, enabling simultaneous monitoring and communication without overloading the network.

In an embodiment, a local (e.g. intermediate) server can be utilized in environments where cameras lack distance-measuring sensors or triangulation capabilities. The local server computes object coordinates by comparing data from multiple cameras with known positions and orientations.

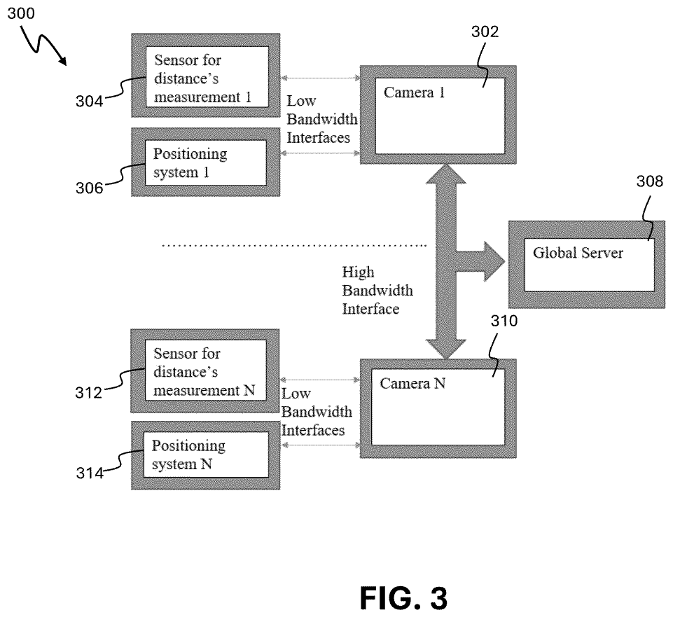

For example, referring to FIG. 3, a block diagram of a system 300 for digital twin synchronization and real-time environment monitoring is depicted, according to an embodiment. System 300 generally comprises camera 1 302, a sensor 304 for camera 1 distance measurement, positioning system 1 306, and a global server 308. System 300 further comprises camera N 310, a sensor 312 for camera N distance measurement, and positioning system N 314. Accordingly, system 300 utilizes a plurality of cameras 1-N (302, 310) which are operably coupled by high bandwidth communication interface(s) to each other and individually to global server 308.

Referring to camera 1 302, sensor 304, and positioning system 1 306, camera 1 302 can utilize low bandwidth interface(s) for communication with (external to camera 1) sensor 304 for distance calculations, and likewise, the same or other low bandwidth interface(s) for communication with positioning system 306 for object positioning calculations. In one aspect, positioning system 306 integrates specific components that facilitate precise object positioning, for example, components such as a GNSS receiver for obtaining precise geographic coordinates, or an inertial measurement unit (IMU) which aids in navigation and position accuracy, improving the object location capabilities of the system. These components are important for determining the camera's exact position within a geographic space and for providing the accuracy of object tracking and positioning calculations relayed between the camera, the sensor, and the digital twin infrastructure.

Global server 308 is configured to aggregate and process data from cameras 1 302 to camera N 310, guaranteeing that information is integrated and presented cohesively in the digital twin environment. Global server 308 orchestrates the overall synchronization of data, providing alignment of all inputs in time and accuracy of the representation in the digital environment.

Coordination between cameras 302 and 310 with global server 308 includes intricate data transmission and synchronization strategies. Each camera feeds into the global server with synchronized, processed data, enabling the server to maintain a unified and updated view of the environment. This multi-source data integration strengthens the system's monitoring and decision-making processes, critical for applications that demand high reliability and precision, such as security surveillance and sophisticated environmental monitoring systems.

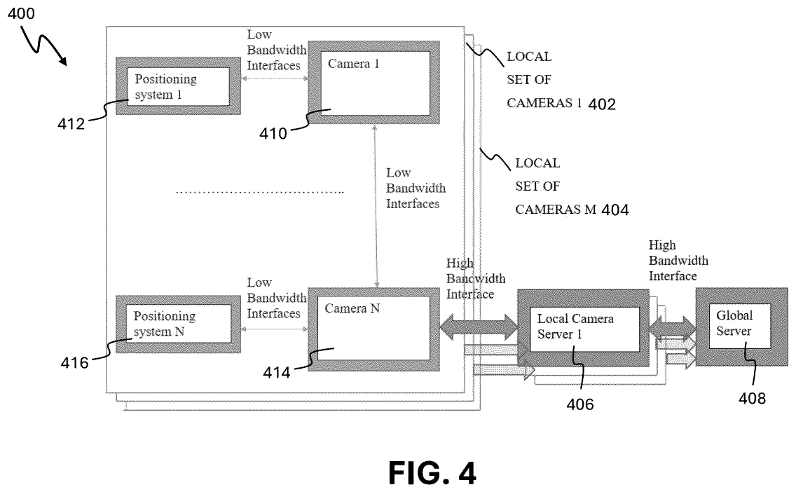

Referring to FIG. 4, a block diagram of a system 400 for digital twin synchronization and real-time environment monitoring using one or more sets of cameras is depicted, according to an embodiment. System 400 generally comprises local set of camera subsystem 1 402 to local set of camera subsystems M 404, a local camera server 406, and a global server 408. As illustrated, local set of camera subsystem 1 402 is depicted and the other local set of camera subsystems to M 404 can include substantially similar components.

Subsystem 1 402 generally comprises camera 1 410, which is operably coupled via low bandwidth interface(s) to positioning system 1 412. Subsystem 1 402 generally comprises a plurality of cameras and positioning systems, such as camera N 414 and positioning system N 416 as illustrated.

Local camera server 1 406 is configured to determine object coordinates by comparing data from multiple cameras 410 to 414 with known positions and orientations. Local camera server 1 406 is configured for processing and integrating data from a designated set of cameras, illustrated as camera 1 410 through Camera N 414. Local camera server 1 406 performs functions including a) data aggregation: collection of data from multiple cameras within an assigned cluster (Local Set of Cameras 1 (402) and Local Set of Cameras M (404)); b) coordinate determination: utilizing the positional data and orientation details provided by the individual cameras' positioning systems (412, 416), local camera server 1 406 calculates the precise coordinates of objects detected by these cameras; c) data synchronization: confirming that the data from various cameras is synchronized in time, which is important for maintaining the integrity and relevance of the information processed; d) error correction and filtering: identifying and correcting any anomalies or errors in the data received from the cameras, which helps to maintain reliable and accurate monitoring system.

Global server 408 is configured to aggregate and manage data from multiple local camera servers, such as local camera server 1 406. Global server 408 is configured to process extensive streams of information received from local servers, each responsible for a subset of cameras within the system. Global server 408 provides the seamless integration of these streams, preserving the overall coherence and accuracy of the digital twin generated from the data. Additionally, global server 408 orchestrates the global synchronization of data across various sources, providing updates to the digital twin timely and reflective of real-world changes. In an embodiment, global server 408 also oversees the performance management of the entire system 400, optimizing data processing and response times across the network. Optimization can include allocating resources efficiently to handle varying loads of data traffic and computational demands, maintaining system stability and high performance under different operational conditions. Moreover, global server 408 can support scalability by dynamically adjusting to the number and complexity of inputs from an expanding network of cameras and local servers. This provides the system scalability without degradation in performance, accommodating growth in both the geographical spread and the density of sensory data inputs.

Each camera subsystem, such as 402 and 404, is specifically configured to handle local environmental conditions and monitoring requirements, feeding into local camera server 1 406 which performs initial data processing tasks. This setup minimizes latency and maximizes the efficiency of data transmission across the network. In an embodiment, camera N 414 is shown directly connected to local camera server 1 406 via a High Bandwidth Interface. This configuration indicates that Camera N 414 may handle more critical or high-priority data, including video, transmissions, requiring direct communication links to provide data fidelity and timely processing.

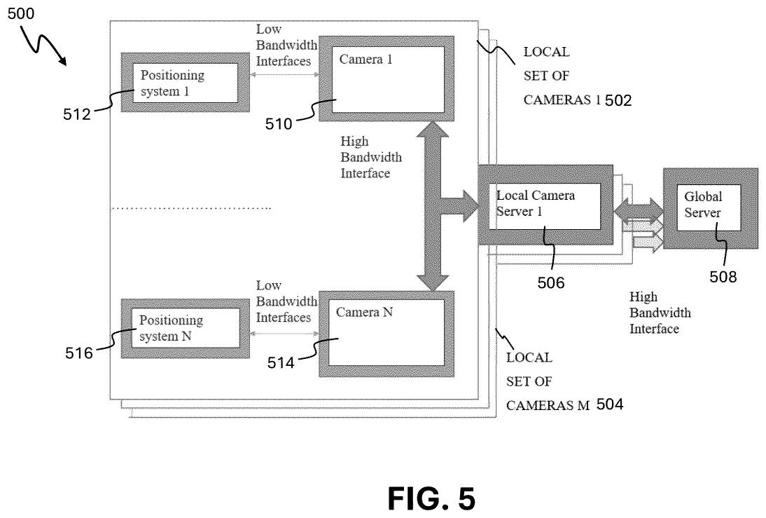

Referring to FIG. 5, a block diagram of a system 500 for digital twin synchronization and real-time environment monitoring using one or more sets of cameras is depicted, according to an embodiment. System 500 generally comprises local set of camera subsystem 1 502 to local set of camera subsystems M 504, a local camera server 506, and a global server 508. As illustrated, local set of camera subsystem 1 502 is depicted and the other local set of camera subsystems to M 504 can include substantially similar components.

Subsystem 1 502 generally comprises camera 1 510, which is operably coupled via low bandwidth interface(s) to positioning system 1 512. Subsystem 1 502 generally comprises a plurality of cameras and positioning systems, such as camera N 514 and positioning system N 516 as illustrated. Camera 1 510 is operably coupled to camera N 514 by high bandwidth interface(s). Camera 1 510 and camera N are also operably coupled to local camera server 1 506.

Local camera server 1 506 acts as a key node within the architecture, tasked with the aggregation, initial processing, and synchronization of data collected from the cameras within its subsystems. Local camera server 1 506 prepares the data for further analysis and integration by global server 508, maintaining data integrity and synchronization throughout the system.

Global server 508 is configured to receive processed and synchronized data from local camera server 1 506 via a high bandwidth interface. Global server 508 performs the role of global data integration, further processing, and the generation of a unified digital twin. Global server 508 handles extensive data inputs from multiple local servers simultaneously and provides system performance and scalability. The coordination between Camera 1 510, Camera N 514, and local cameras server 1 506 highlights the capability of system 500 to manage and synchronize data from cameras with varying data priorities and transmission requirements.

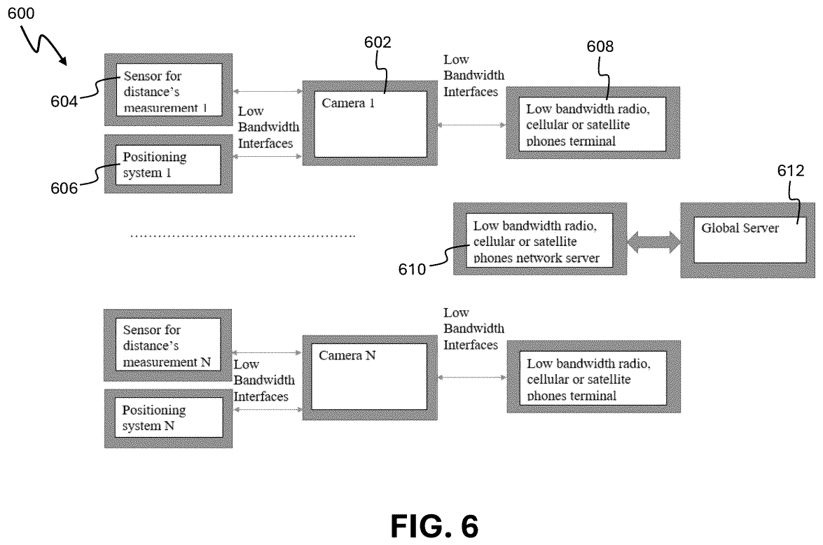

Referring to FIG. 6, a block diagram of a system 600 for digital twin synchronization and real-time environment monitoring using one or more sets of cameras is depicted, according to an embodiment. System 600 generally comprises camera 1 602, a sensor 604 for camera 1 distance measurement, positioning system 1 606, a low bandwidth wireless terminal 608, a low bandwidth server 610, and a global server 612.

Likewise, system 600 comprises a plurality of cameras N in communication with low bandwidth wireless server 610 via a low bandwidth terminal and associated sensors N, positioning systems N similar to those described with respect to camera 1 602, but not labeled for ease of illustration.

Low bandwidth terminal 608 is configured to facilitate the efficient transmission of data using radio, cellular, or satellite technologies. Low bandwidth terminal 608 serves as an interface that connects the cameras and their respective sensors to the broader network infrastructure, ensuring that data is transmitted even in areas with limited connectivity options. The operational design of low bandwidth terminal 608 emphasizes minimal bandwidth utilization, optimizing system performance while managing data transmission costs and complexity. For example, low bandwidth terminal 608 can implement wireless protocols such as radio, cellular, and satellite.

Low bandwidth server 610 is configured to act as a central node within the system 600. Low bandwidth server 610 processes and refines data received from multiple low bandwidth terminals 608, preparing such data for subsequent transmission to global server 612. Low bandwidth server 610 is configured for data aggregation, compression, and preliminary analysis, which are important for reducing the volume of data that must be handled by higher-tier systems. This architecture is instrumental in maintaining the efficacy and scalability of the digital twin synchronization process, particularly in expansive monitoring environments.

Collectively, low bandwidth terminal 608 and low bandwidth server 610 form a robust framework for data handling within system 600. This configuration not only improves the reliability of data transmission across potentially unstable or low-capacity network links but also guarantees that data integrity and timeliness are upheld, thereby supporting real-time monitoring and synchronization tasks. This configuration is particularly advantageous in remote or infrastructure-limited environments, where traditional high-bandwidth solutions may not be feasible.

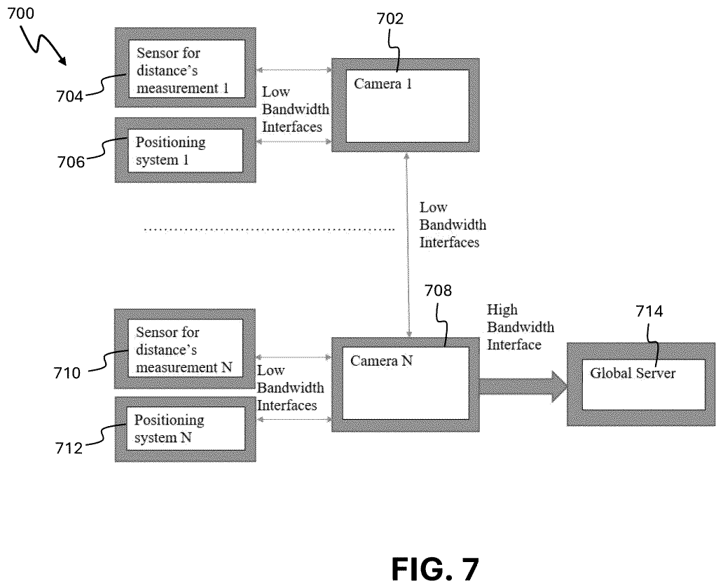

Referring to FIG. 7, a block diagram of a system 700 for digital twin synchronization and real-time environment monitoring using one or more sets of cameras is depicted, according to an embodiment. System 700 generally comprises camera 1 702, a sensor 704 for camera 1 distance measurement, positioning system 1 706, and a global server 714. System 700 further comprises camera N 708, a sensor 710 for camera N distance measurement, and positioning system N 712. Accordingly, system 700 utilizes a plurality of cameras 1-N (702, 708) which are operably coupled by low bandwidth communication interface(s) to each other. As illustrated, camera N 708 can be operably coupled by high bandwidth interface(s) to global server 714.

All cameras, including camera 1 702 and camera N 708, are linked via low bandwidth interfaces. In one aspect, the low bandwidth interfaces are critical for efficient data transmission that requires minimal bandwidth. Low bandwidth interfaces are particularly beneficial in environments where data transmission costs need to be minimized, or where bandwidth availability is constrained. Camera N 708 is configured to obtain camera 1 702 classification results supplemented with positioning system 1 706 and sensor 704 results and, finally, provide global server 714 with the classification result, including coordinates of the object calculated based on data received from other cameras via low bandwidth interface.

Notably, camera N 708 is distinctively configured to connect directly to global server 714 via a high bandwidth interface. A high bandwidth interface connection is configured to handle large volumes of data, for example, video data or data that requires rapid processing, which is critical for real-time applications such as dynamic environment monitoring and immediate data synchronization needs. The high bandwidth interface allows global server 714 to obtain data from Camera N due to its strategic placement or critical monitoring role.

Global server 714 serves as the central processing unit for system 700, integrating data received from Camera N 708. Global server 714 is configured for processing data received from Camera N 708 to update and maintain the digital twin.

The configuration of system 700, especially the direct high bandwidth connection from Camera N 708 to global server 714, underscores the system's flexibility and scalability. This design allows for differentiated data handling where critical data paths are optimized for higher performance.

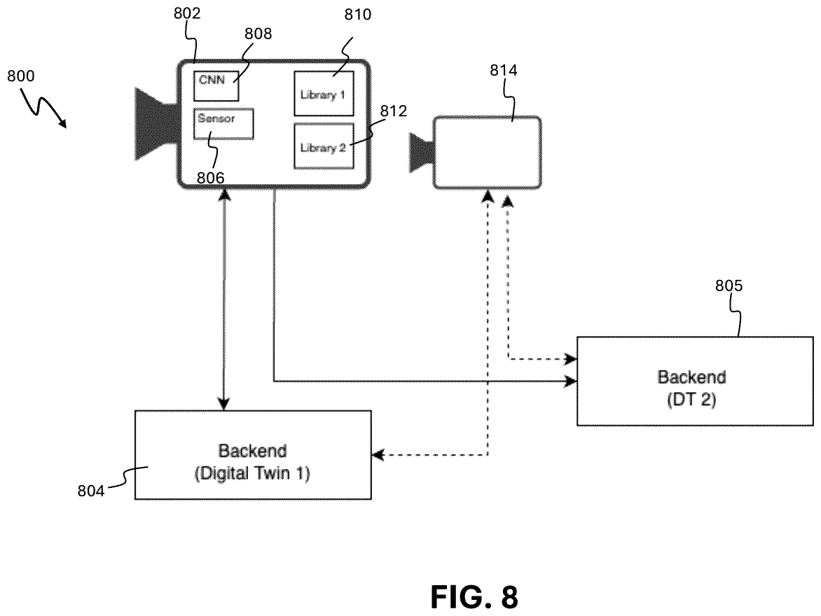

Referring to FIG. 8, a block diagram of a system 800 for digital twin synchronization and real-time environment monitoring using one or more sets of cameras is depicted, according to an embodiment. System 800 generally comprises a camera 802, a first digital twin 804, and a second digital twin 805.

In an embodiment, camera 802 can comprise a sensor 806, a CNN 808, and one or more libraries, such as library 810 and library 812. In one aspect, each library can comprise definitions of different objects for different digital twins. For example, library 810 can be used to update digital twin 804. In another example, library 812 can be used to update digital twin 805.

In operation, camera 802 captures real-time data through sensor 806, which is then processed by CNN 808 to classify and identify objects based on the criteria defined in the relevant libraries. For instance, objects detected and classified using Library 1 810 are specifically formatted and transmitted to update Digital Twin 1 804, while data processed through Library 2 812 is directed towards Digital Twin 2 805. This dual-library approach allows for the segregation of data streams based on their destination and purpose, optimizing the update cycles and relevance of each digital twin.

Additionally, system 800 can include an optional second camera, camera 814, which can be similarly equipped with its own sensor and CNN, potentially using the same or different libraries as camera 802. Camera 814 serves as a redundancy or expansion module, improving the ability of system 800 for data acquisition capabilities and providing additional data streams to either or both digital twins 804, 805 as required.

The synchronization between the two digital twins, Digital Twin 1 804 and Digital Twin 2 805, is primarily managed through the selective routing of data from camera 802 and potentially camera 814. In an embodiment, the control and calculation engine 212 is configured to handle the selective routing within system 800. This engine is equipped to interact directly with the CNN 808 and the associated libraries (Library 1 (810) and Library 2 (812)), facilitating the decision-making process regarding which data should be sent to each digital twin. In one aspect, control and calculation engine 212 analyzes the output from the CNN 808, determining the relevance of detected objects based on the criteria defined in each library. Control and calculation engine 212 then decides the appropriate digital twin for the data update. In another aspect, once an object is classified, control and calculation engine 212 automatically routes the data to Digital Twin 1 (804) or Digital Twin 2 (805) based on the matching library criteria. Each digital twin receives updates that are specific to the predefined object models and operational parameters stored in their respective libraries. This targeted approach provides each digital twin with updates, reflecting real-time changes in the environment with minimal delay.

Embodiments therefore provide synchronization between a camera and one or more digital twins for recognized objects. In the CNN model and its corresponding dataset, each object class is associated with a textual description and an integer index. Different datasets for a single CNN, as well as different CNN models, can have entirely independent sets of recognized objects. On the other hand, digital twin systems can use their own identifiers for displaying avatars, which typically encompass a significantly larger range of object types than a specific CNN model can recognize within its dataset.

To ensure synchronization between various digital twin visualization systems and multiple independently operating cameras—each potentially utilizing different types and models of CNNs trained on distinct datasets—a mechanism for dynamically verifying and adjusting the compatibility of current object type sets is required. Accordingly, the camera is configured with a lookup table (LUT) that maps the indices of objects identified by the CNN to those used by the digital twin system. The lookup table can be updated as needed. The object index descriptions are stored as LUT tables, while the textual descriptions of object classes are kept in ASCII and XML file formats. Both the tables and files are accessible for reading and writing, allowing for dynamic updates and adjustments.

A Lookup Table (LUT) serves as a translation mechanism between the object indices identified by the camera's CNN and the indices used by the digital twin systems. A simplified example a LUT is presented below:

| CNN | Digital Twin | |
|---|---|---|
| Object ID | Object ID | Object Class Description |
| 001 | A100 | Vehicle - Car |
| 002 | A200 | Pedestrian - Adult |
| 003 | A300 | Traffic Signal - Stop Light |
| 004 | A400 | Animal - Dog |
| 005 | A500 | Obstacle - Construction Barrier |

Column “CNN Object ID” represents unique identifiers assigned to objects as they are recognized by the CNN within the camera system. These IDs are specific to the CNN's trained dataset. Column “Digital Twin Object ID” includes corresponding identifiers used within the digital twin's system. These IDs may differ from the CNN Object IDs due to different system requirements or designations within the digital twin environment. Column “Object Class Description” provides a human-readable description of what each ID represents, which can help in maintaining the LUT and understanding the data. This description is useful for debugging and system oversight, and can be stored in various formats like ASCII or XML for easy integration and updates. LUT provides seamless integration between the camera's detection capabilities and the digital twin's representation requirements. The LUT table can be dynamically updated if new objects are added to the CNN's detection capabilities or if the digital twin's specifications change, making the system adaptable and scalable.

Use of a LUT provides flexibility and guarantees that diverse digital twin systems and edge devices, even when operating with different CNN models and datasets, can maintain consistency in object identification and representation.

With respect to processing object distance data, all distance data received from external sensors, including decoding, processing, and correlating this information with the recognized image data from the CNN, is handled entirely onboard the camera. Such edge-based processing provides integrated distance measurements and object detection without relying on external systems.

In the case where a camera is equipped with two video sensors, each using similar optical systems, the analysis of the relative position and distance of classified objects can be performed using image triangulation (or parallax method). Image triangulation provides distance measurement without the need for external sensors, as the system calculates object distance based on the overlap and perspective differences between the two video feeds.

Further, with reference to systems 400, 500 as examples, where cameras lack external sensors and cannot independently determine object distances, a local intermediate server (e.g. local camera server 406, 506) is employed. This server is configured to perform dynamic analysis and calculates the coordinates of objects observed by multiple cameras. Each camera has known spatial coordinates and orientation, allowing the server to cross-reference object identifiers, timestamps, and image coordinates received from the CNNs of these cameras. By correlating the data from multiple perspectives, the local intermediate server computes the spatial position of the detected objects. The calculated positional information is then transmitted to the digital twin system for visualization.

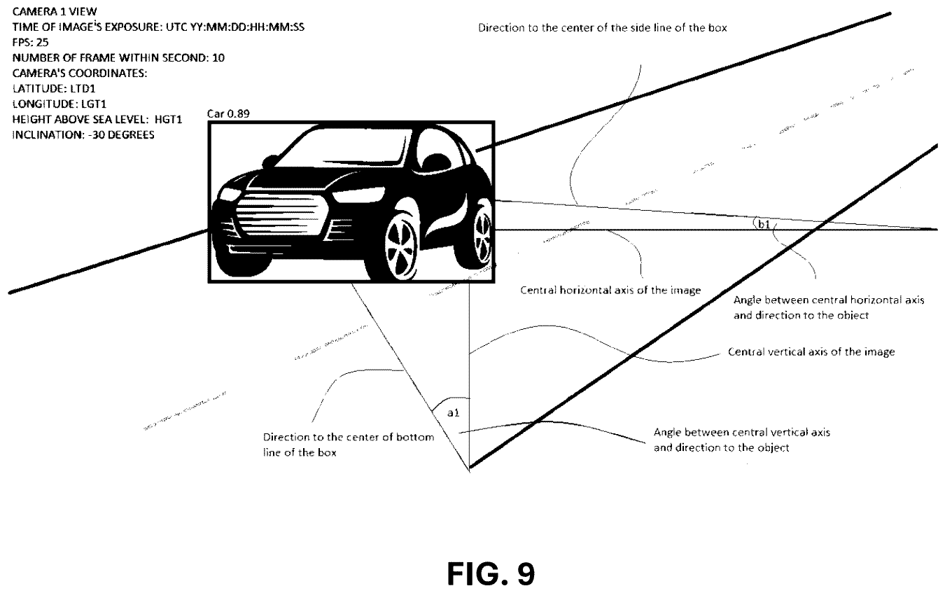

Referring to FIGS. 9-12, various illustrations of different camera setups and configurations are depicted, which can each achieve precise object localization by integrating timestamp synchronization, spatial orientation calibration, and multi-angle measurement techniques.

Referring to FIG. 9, an illustration of calculations for an unsynchronized camera setup for digital twin synchronization and real-time environment monitoring is depicted, according to an embodiment.

In one aspect, FIG. 9 illustrates an example where multiple cameras are not synchronized. Each camera has a different frame rate and possibly different image formats, and the cameras can be positioned at varying distances from the object. Despite these differences, embodiments can match frames from different cameras by using timestamps provided by the positioning system, which calculates the precise time of each frame. By knowing the camera positions (e.g. using location data from the positioning system) and their orientation (e.g. pre-determined by calculating the central axis of the field of view during camera installation or dynamically calibrated using an orientation marker, such as a compass or the direction towards a known object in the frame), the system aligns the images from different cameras.

In one aspect, the calculation of an object's coordinates can be performed onboard one of the cameras if the cameras are connected via an interface, or on a local server if there is no connection. Regardless of the setup, the computed coordinates of the object can be sent to the central server for further analysis and display. The accuracy of object coordinate calculation improves with better synchronization of the cameras, reducing potential errors.

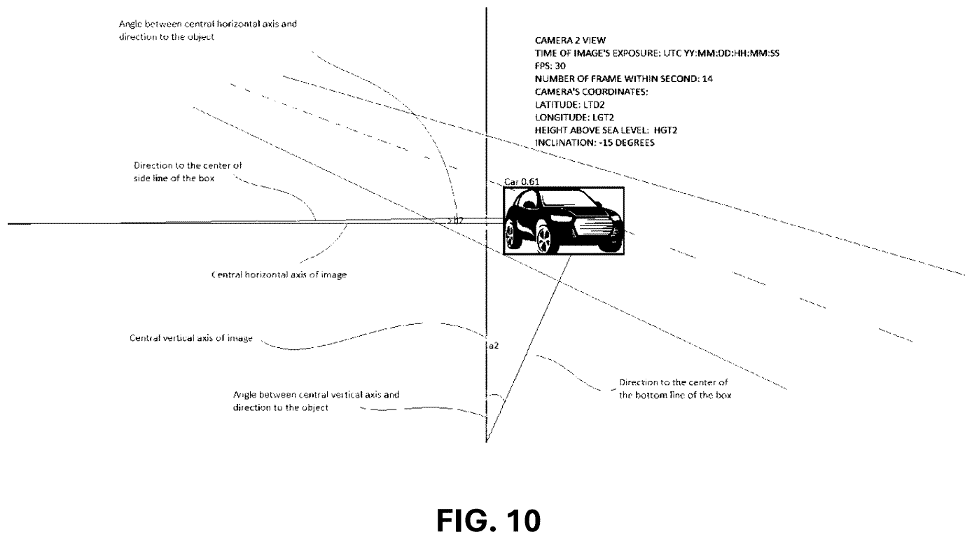

Referring to FIG. 10, an illustration of calculations for a synchronized camera setup based on timestamp for digital twin synchronization and real-time environment monitoring is depicted, according to an embodiment. In one aspect, object coordinates are determined based on the function of camera parameters such as latitude (LTD1, LTD2), longitude (LGT1, LGT2), and height above sea level (HGT1, HGT2). Embodiments utilize such camera parameter values, combined with angles measured in both horizontal and vertical planes, to estimate the object's location precisely. Knowing the horizontal alignment of the camera allows embodiments to calculate the object's height relative to the camera, providing a complete spatial position.

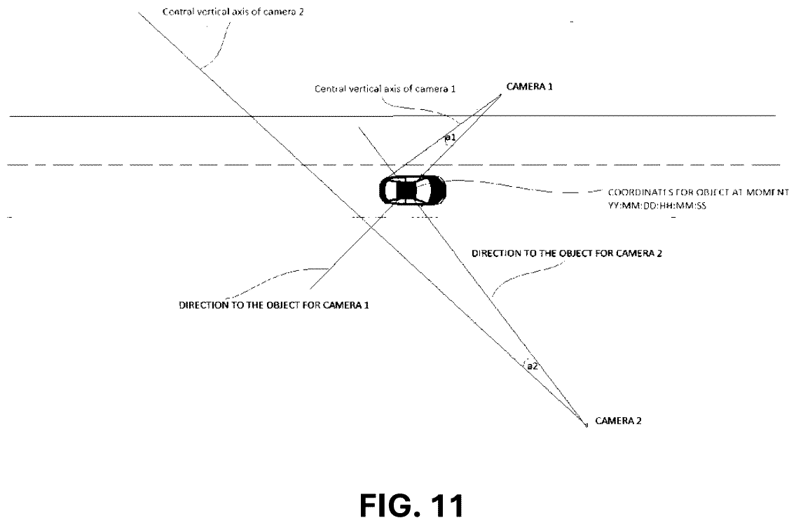

Referring to FIG. 11, an illustration of calculations for a camera setup based on vertical and horizontal angles of objects for digital twin synchronization and real-time environment monitoring is depicted, according to an embodiment. In one aspect, both vertical angles and horizontal angles are used to calculate the object's position. By utilizing the known horizontal setup of the camera and its vertical inclination, embodiments can determine the height of the object relative to the camera's position. This approach allows flexibility in defining the object's position, either using the base level of the object (e.g., the lowest point) or its geometric center, based on the vertical angle measured from the camera's perspective.

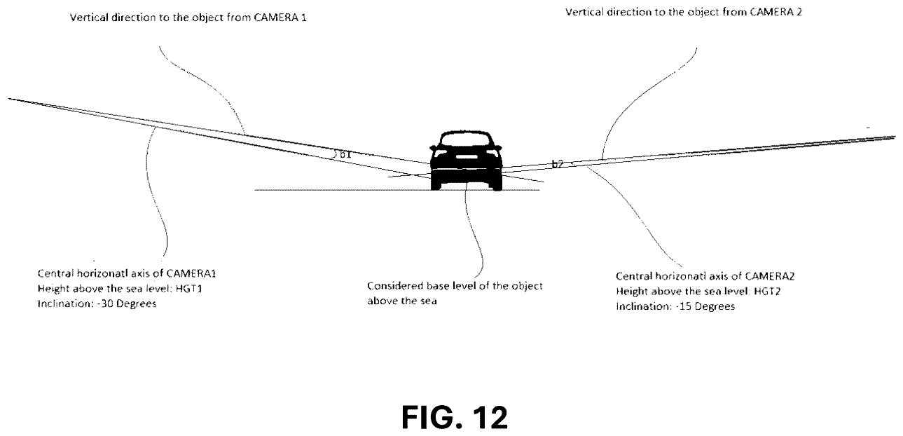

Referring to FIG. 12, an illustration of calculations for a camera setup based on camera positioning characteristics for digital twin synchronization and real-time environment monitoring is depicted, according to an embodiment. In one aspect, positioning characteristics of the cameras, such as inclination and elevation above sea level, influence the coordinate calculations. For each camera, data such as the height above sea level (HGT1, HGT2) and inclination angle (−30 degrees, −15 degrees) are used to refine the calculation of the object's spatial coordinates, taking into account both the central axis of the image and any variations in the camera's tilt.

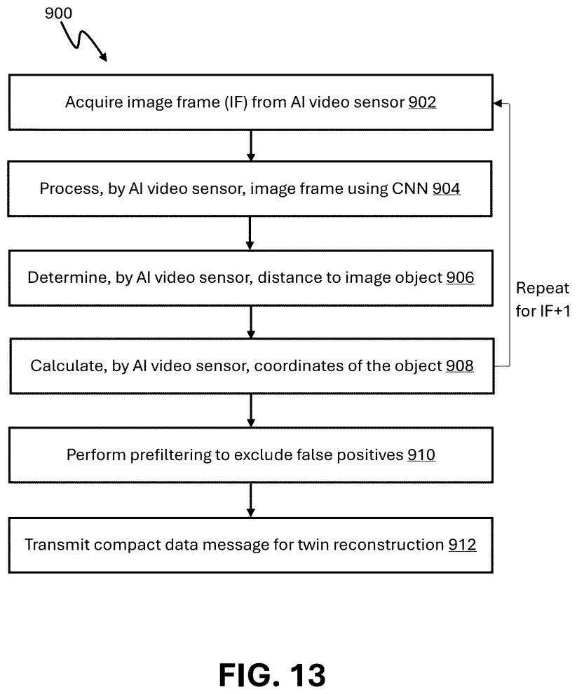

Referring to FIG. 13, a method 900 of digital twin synchronization and real-time environment monitoring is depicted, according to an embodiment.

At 902, an image frame (IF) is acquired by an AI video sensor. For example, an image sensor can be triggered to capture real-time image frame(s) for a physical space.

At 904, the IF is processed using a CNN onboard the AI video sensor. For example, processing the IF can include identifying an object class, determining a probability of recognition of the object, performing pose estimation, or determining coordinates of the object within the image frame IF.

At 906, a distance to an image object is determined. For example, distance to an object can be determined by using external sensors, or triangulating with at least two video sensors having known fields of view and distances between the sensors.

At 908, the AI video sensor calculates coordinates of the object within the physical space. For example, coordinates can be calculated using GNSS coordinates of the AI video sensor. In other examples, coordinates of the object can be determined using image data and/or image metadata.

From 908, operations 902-908 are performed for the next image frame (IF+1).

At 910, prefiltering is performed for the determined object's information to exclude false positives of the object's identification and coordinates. In one aspect, the speed and direction of an object's movement can be estimated by comparing the object position from a set of continuous frames. In this case, a next position can be predicted with certain accuracy and make a warning (or repeat the measurement) when the object's position does not match the prediction. In one aspect, the objects can be tracked within the set of frames. An incorrect CNN detection can be determined if a new type of object is made by the CNN, for example, in the middle of observing a scene where only already-known objects are expected.

In one aspect, prefiltering includes tracking mutual positions and relative movements of objects from frame to frame using an analytical algorithm, such as a Kalman filter, to filter out errors due to overlapping objects from different angles, incorrect object type or position determination due to convolutional neural network failures, glare in the image frame, or similar effects that are vulnerabilities of such systems.

At 912, the AI video sensor transmits a compact data message to a remote backend for dynamically reconstructing digital twin. In one aspect, the compact message can include the object class, direction, pose, timestamp, AI video sensor ID, and coordinates of the object. In one particular aspect, the compact message includes only the aforementioned fields.

1. A method of creating a digital twin of a physical environment, the method comprising:
acquiring a real-time image frame (IF) by at least one AI video sensor positioned in the physical environment;
processing, by the at least one AI video sensor, the IF using a convolutional neural network (CNN), for an object in the IF using an object library on the AI video sensor:
identify an object class,
determine a probability of recognition of the object,
perform pose estimation for the object, and
determine coordinates of the object within the IF;
determining, by the AI video sensor, a distance to the object by at least one of using an external sensor or triangulating with at least two video sensors having known fields of view and distances between sensors;
calculating, by the AI video sensor, coordinates of the object within the physical space;
repeating the acquiring, processing, determining, and calculating for a next image frame (IF+1);
performing, by the AI video sensor, prefiltering to exclude false positives of the object or the coordinates of the object using IF and IF+1 as prefiltered object information;
transmitting, by the AI video sensor, the prefiltered object information as a compact data message to a remote backend for dynamically reconstructing the digital twin, the compact message including: the object class, an object direction, the pose estimation, a timestamp, an AI video sensor ID, and the coordinates of the object.

2. The method of claim 1, wherein the CNN is pretrained based on a training image dataset unique to the object library on the AI video sensor and an object library on the digital twin.

3. The method of claim 1, wherein calculating the coordinates of the object within the physical space comprises using a global navigation satellite system (GNSS) receiver connected and synchronized with the AI video sensor, allowing determination of the position and orientation relative to the known position of one or more satellites at a strictly defined moment in time.

4. The method of claim 1, wherein calculating the coordinates of the object within the physical space comprises a determination using topographic references to the terrain, including by at least one of a map, a compass, a chronometer, a barometer, a sextant, an external GNSS receiver, an analysis of the location of known objects in the IF, or an operator command.

5. The method of claim 1, wherein calculating the coordinates of the object within the physical space comprises applying a vectorized map to the IF.

6. The method of claim 1, wherein calculating the coordinates of the object within the physical space further comprises applying a non-vectorized map to the IF including by
determining at least one landscape feature in the IF using a convolutional neural network (CNN) in conjunction with stored landscape data, and
correlating the at least one landscape feature to the object.

7. The method of claim 1, further comprising:
synchronizing a plurality of AI video sensors and with respective external sensors for determining the distance to an object, including at least one of:
applying a GNSS receiver connected and synchronized with the plurality of AI video sensors, to determine position and orientation relative to the known position of one or more satellites at a strictly defined point in time,
hardware synchronization by a common synchronization pulse via general-purpose input/output (GPIO) or sending a message via a cross-board interface, or
connecting to an Ethernet network using Network Time Protocol (NTP).

8. The method of claim 1, wherein the AI video sensor is configured to selectively transmit information about the object based on predefined criteria.

9. The method of claim 8, wherein the predefined criteria includes object importance.

10. The method of claim 1, wherein the AI video sensor transmits object information when the object changes position, appears or disappears in the frame, or changes pose.

11. The method of claim 1, further comprising:
upon authorization, transmitting, by the AI video sensor, encrypted image frames or sequences of image frames, in addition to the compact message.

12. The method of claim 1, wherein the prefiltering includes tracking mutual positions and relative movements of objects from frame to frame to filter out errors due to at least one of:
overlapping objects from different angles,
incorrect object type or position determination due to CNN failures, or
glare in the image frame.

13. The method of claim 1, wherein the prefiltering further includes filtering the object information based on predefined rules.

14. An edge device, comprising:
at least one image sensor positioned in a physical space;
an object library;
at least one processor and a memory operably coupled to the at least one processor;
instructions that, when executed by the at least one processor, cause the edge device to implement:
triggering the at least one image sensor to capture a real-time image frame (IF),
a convolutional neural network (CNN) trained based on the object library configured to process the IF for the object library, and configured to, for an object in the IF using the object library, identify an object class, determine a probability of recognition of the object, perform pose estimation for the object, and determine coordinates of the object within the IF,
an object coordination engine configured to:
determine a distance to the object by at least one of using an external sensor or triangulating with at least two video sensors having known fields of view and distances between sensors,
calculate coordinates of the object within the physical space, and
repeating the acquiring, processing, determining, and calculating for a next image frame (IF+1);
wherein the object coordination engine is further configured to prefilter to exclude false positives of the object or the coordinates of the object using IF and IF+1 as prefiltered object information;
the instructions further comprising an edge communication engine configured to transmit the prefiltered object information as a compact data message to a remote backend for dynamically reconstructing the digital twin, the compact message including: the object class, an object direction, the pose estimation, a timestamp, an AI video sensor ID, and the coordinates of the object.

15. The edge device of claim 14, wherein the CNN is pretrained based on a training image dataset unique to the object library on the AI video sensor and an object library on the digital twin.

16. The edge device of claim 14, wherein prefiltering to exclude false positives includes modeling the coordinates of the object using an initial set of frames to forecast an object trajectory and excluding the prefiltered object information when a detected object trajectory does not match the forecast.

17. The edge device of claim 14, wherein the edge communication engine is configured to transmit the compact message to the remote backend for less than all images frames.

18. A system comprising:
a first image sensor positioned in a physical space;
a first positioning subsystem configured to determine first positional data for an object in a first image frame (IF) captured by the first image sensor;
a first camera configured with a convolutional neural network (CNN) trained based on an object library configured to process the first IF for an object library associated with a digital twin, and configured to, for an object in the first IF using the object library and the first positional data, determine object information in the first IF including an object class, an object direction, a pose estimation, and object coordinates;
a second image sensor positioned in the physical space;
a second positioning system configured to determine second positional data for an object in a second image frame (IF) captured by the second image sensor;
a second camera configured with a convolutional neural network (CNN) trained based on an object library configured to process the second IF for the object library, and configured to, for an object in the second IF using the object library and the second positional data, determine object information in the second IF including an object class, an object direction, a pose estimation, and object coordinates;
a global server configured to:
receive, over a high bandwidth interface, the object information of the first camera and the second camera,
aggregate the object information of the first camera and the second camera as aggregated object information,
synchronize the aggregated object information as synchronize aggregated object information, and
transmit the synchronized aggregated object information to the digital twin.

19. The system of claim 18, further comprising:
a local server configured to determine object coordinates by comparing the object information of the first camera and the second camera with known positions and orientations and filtering the compared object information data before transmitting to the global server.

20. The system of claim 19, wherein the first camera and the second camera are coupled via low a bandwidth interface, wherein the second camera is configured to communicate first camera data with the local server without the first camera communicating with the local server.
